(19) United States
(12) Patent Application Publication
(10) Pub. No.: US 2014/0054147 A1
(43) Pub. Date: Feb. 27, 2014

(54) Rotational Control Mechanism for an Electrical Tool

(71) Applicant: Dancheng Yang, Shenzhen City (CN)

(72) Inventor: Dancheng Yang, Shenzhen City (CN)

(73) Assignee: Wing LI, Stanley, Hong Kong (CN)

(21) Appl. No.: 13/824,996

(22) PCT Filed: Sep. 20, 2012
(86) PCT No.: PCT/CN2012/081651

§ 371 Date: Mar. 18, 2013

(30) Foreign Application Priority Data
Sep. 26, 2011 (CN) 201120364069.4

(51) Int. Cl. H01H 3/06

(52) U.S. Cl. CPC H01H 3/06
USPC 200/335

(57) ABSTRACT

The present invention relates to a rotational control mechanism for an electrical tool comprising a micro switch having a triggering portion, a frame to securely dispose the micro switch, a revolver pivotally connected on the frame via a rotating shaft, and a triggering element disposed on and paralleled with an inner lateral wall of the revolver to trigger the triggering portion of the micro switch of the frame. The rotational control mechanism is benefited via the revolver pivotally connected with the frame, and the triggering element disposed on the inner lateral wall of the revolver and parallel with the wall to trigger the triggering portion of the micro switch, therefore overcomes shortcomings of the existing control mechanism including the revolver being unable to rotate and the triggering portion tending to be false triggered easily, and achieves technical effects of flexible and reliable control, stable performance, compact structures and reliable transmission.

### TECHNICAL FIELD

The present invention relates to a switch control mechanism, and especially to a rotational control mechanism for an electrical tool.

### DESCRIPTION OF BACKGROUND

A current switch control mechanism for an electrical tool, for example, a revolver of an electric screwdriver is utilized to control turning on or shutting down of an electrical machine of the electric screwdriver by using a trough disposed on a top face of a lateral wall of the revolver to trigger a triggering portion of a micro switch when the revolver rotates. However, the present inventor found that the current switch control mechanism for the electrical tool has technical problems as described following during inventing the present invention. First of all, the revolver may be unable to rotate when the triggering portion happens to block the trough. Secondly, the triggering portion exposes outside and tends to easily false triggering, and as a result, control of the switch control mechanism is not flexible and reliable.

### SUMMARY

An object of the present invention is to solve existing problems and to provide a rotational control mechanism for an electrical tool which has advantages of having flexible and reliable control, stable performance, compact structures, and reliable transmission.

To achieve the above objects, inventive embodiments of the present invention provides a rotational control mechanism for an electrical tool comprising a micro switch having a triggering portion and further comprising a frame for the micro switch being securely disposed thereon, a revolver pivotally connected on the frame via a rotating shaft, and a triggering element being disposed on an inner lateral wall of the revolver and being parallel with the inner lateral wall to trigger the triggering portion of the micro switch disposed on the frame.

Furthermore, a trough is disposed on an edge of the triggering element, and symmetric curve surfaces are convexly formed on two edges of the trough. The triggering portion engages within the trough and is gradually retracted out of or inserted into the trough in conjunction with rotation of the revolver.

Furthermore, a torsion spring is further securely disposed on the frame. Two extension ends of the torsion spring respectively engage with two corresponding ends of an inner of the revolver.

Furthermore, a potentiometer is further securely disposed on the frame. A gear is disposed on the potentiometer to be rotated for adjusting electrical resistance values of the potentiometer. A rack is disposed on a top face of a lateral wall of the revolver opposite to the triggering element and engages with the gear.

Furthermore, a first through hole is disposed on the frame. Two second through holes corresponding to the first through hole are respectively disposed on two lateral walls of the revolver. The two second through holes are coaxial along a same straight line. The rotating shaft penetrates through the first through hole and the two second through holes.

Furthermore, the micro switch is a button type, a spring roller type, a lever roller type, or a short triggering arm type micro switch.

Beneficial effects of the inventive embodiments of the present invention are described following. Through the revolver pivotally connected with the frame, and the triggering element disposed on the inner lateral wall of the revolver and parallel with the lateral wall to trigger the triggering portion of the micro switch, the shortcomings of the current control mechanism mentioned above including the revolver being unable to rotate and the triggering portion tending to be false triggered easily are therefore overcome. The technical effects of flexible and reliable control, stable performance, compact structures and reliable transmission are further achieved.

### DESCRIPTION OF THE DRAWINGS

FIG. 1 is a structural schematic view of a side of a rotational control mechanism for an electrical tool in accordance with an embodiment of the present invention.

FIG. 2 is an exploded schematic view of the rotational control mechanism depicted in FIG. 1.

FIG. 3 is a structural schematic view of another side of the rotational control mechanism depicted in FIG. 1.

### DETAILED DESCRIPTION OF THE EMBODIMENTS

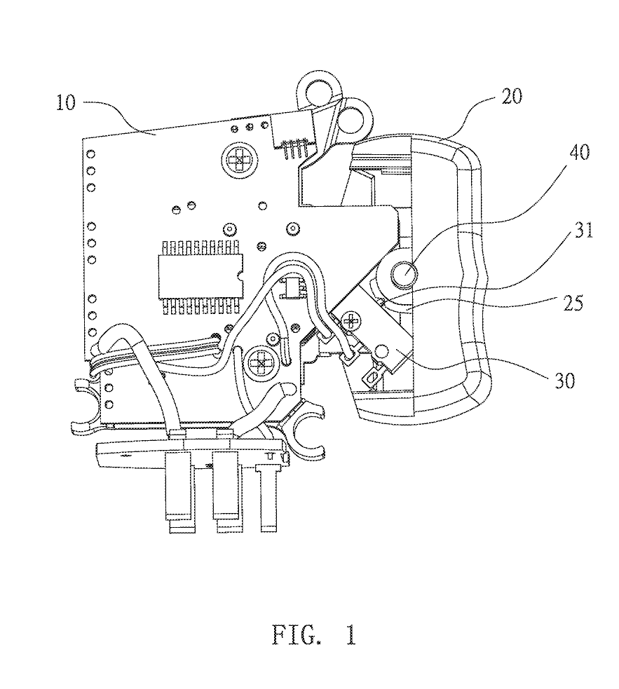

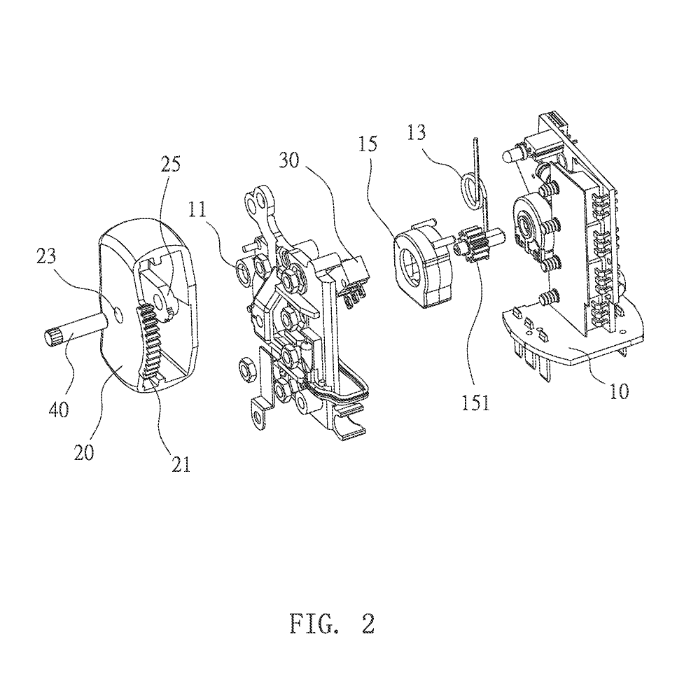

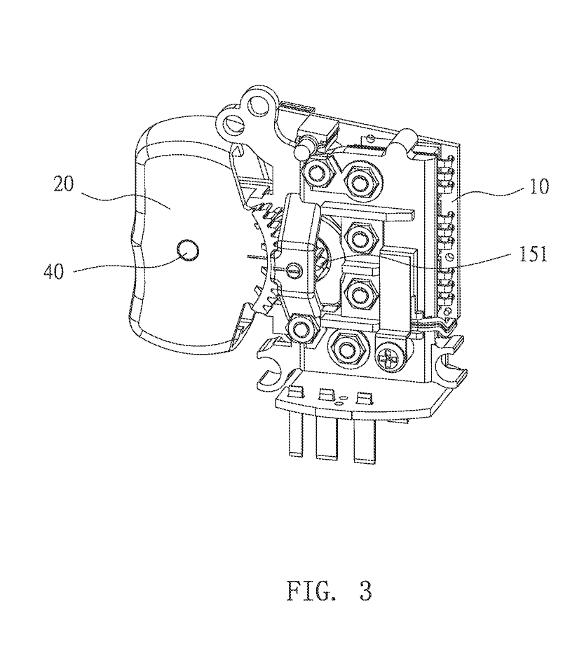

Referring to FIGS. 1-3, a rotational control mechanism used for an electrical tool is provided in accordance with an embodiment of the present invention. The rotational control mechanism comprises a frame 10, a revolver 20, and a micro switch 30 and a rotating shaft 40 both of which are disposed on the frame 10.

The frame 10 comprises a circuit board and a heat sink connecting with the circuit board. A first through hole 11, a torsion spring 13, and a potentiometer 15 are disposed on the frame 10.

Two extending ends of the torsion spring 13 respectively engage with two corresponding ends of an inner of the revolver 20. A middle portion of the torsion spring 13 is securely disposed on the frame 10. As a result, the torsion spring 13 is capable of enabling the revolver 20 to restore to an originals position thereof. After the revolver 20 rotates clockwise or counterclockwise at a predetermined angle under user operation, the revolver 20 can be restored to the original position thereof via a resilient restoring force of the torsion spring 13.

A gear 151 is disposed on the potentiometer 15 to be rotated for adjusting electrical resistance values of the potentiometer 15. A rack 21 is disposed on a top face of a lateral wall of the revolver 20 to be engaged with the gear 151.

The revolver 20 is substantially in a ship shape, and comprises two second through holes 23 corresponding to the first through hole 11 and being coaxial along a same straight line. The second through holes 23 are respectively disposed on two lateral walls of the revolver 20.

A triggering element 25 is disposed on an inner lateral wall of the revolver 20 and is parallel with an extension direction of the inner lateral wall to trigger a triggering portion 31 of the micro switch 30. A trough is disposed on an edge of the triggering element 25, and symmetric curve surfaces are convexly formed on two edges of the trough. The triggering portion 31 engages within the trough, and is gradually retracted out of or inserted into the tough in conjunction with rotation of the revolver 20. The rack 21 is disposed on the lateral wall of the revolver 20 opposite to the triggering element 25.

The micro switch 30 is either a button type, a spring roller type, a lever roller type, or a short triggering arm type micro switch.

The rotating shaft 40 is accommodated in the first through hole 11 and the second through holes 23 so as to rotationally connect the frame 10 with the revolver 20. In other words, the revolver 20 is pivotally connected with the frame 10 via the rotating shaft 40.

Working processes of the rotational control mechanism used for an electrical tool are described as follows. When the revolver 20 is rotated clockwise due to user operation, the triggering element 25 rotates simultaneously to trigger the triggering portion 31 and to turn on the micro switch 30 in order for initiating an electrical machine rotating. Accordingly, the rack 21 moves and simultaneously drives the gear 151 of the potentiometer 15 to rotate for adjusting electrical resistance so as to adjust a rotational speed of the electrical machine When the revolver 20 is rotated counterclockwise due to user operation, difference between the present working processes and the above-mentioned processes is that the electrical machine rotates along an opposite direction.

The above mentioned is only exemplary embodiments of the present invention. It should be noted, for persons of ordinary skill in this art field, improvements and modifications within the spirit of the present invention can be further made, and such improvements and modifications should be seemed to be included in the claimed scope of the present invention.

What is claimed is:

1. A rotational control mechanism for an electrical tool, comprising a micro switch having a triggering portion, wherein the rotational control mechanism further comprises:
a frame, the micro switch being securely disposed thereon; and
a revolver pivotally connected on the frame via a rotating shaft, and a triggering element being disposed on an inner lateral wall of the revolver and parallel with the inner lateral wall to trigger the triggering portion of the micro switch disposed on the frame.

2. The rotational control mechanism for an electrical tool as claimed in claim 1, wherein a trough is disposed on an edge of the triggering element, and symmetric curve surfaces are convexly formed on two edges of the trough, the triggering portion engages within the trough, and is retracted out of or inserted into the trough in conjunction with rotation of the revolver.

3. The rotational control mechanism for an electrical tool as claimed in claim 1, wherein a torsion spring is securely disposed on the frame, and two extension ends of the torsion spring respectively engage with two corresponding ends of an inner of the revolver.

4. The rotational control mechanism for an electrical tool as claimed in claim 1, wherein a potentiometer is further securely disposed on the frame, and a gear is disposed on the potentiometer to be rotated for adjusting electrical resistance values of the potentiometer, and a rack is disposed on a top face of a lateral wall of the revolver opposite to the triggering element and engages with the gear.

5. The rotational control mechanism for an electrical tool as claimed in claim 1, wherein a first through hole is disposed on the frame, two second through holes corresponding to the first through hole are respectively disposed on two lateral walls of the revolver, the two second through holes are coaxial along a same straight line, and the rotating shaft penetrates through the first through hole and the two second through holes.

6. The rotational control mechanism for an electrical tool as claimed in claim 1, wherein the micro switch is a button type, a spring roller type, a lever roller type, or a short triggering arm type micro switch.
